(19) United States
(12) Patent Application Publication
(10) Pub. No.: US 2011/0297464 A1
(43) Pub. Date: Dec. 8, 2011

(54) SELF PROPELLED TOOLBOX

(76) Inventor: SAMUEL N. ROBBINS, Lithia, FL (US)

(21) Appl. No.: 12/794,730

(22) Filed: Jun. 5, 2010

(51) Int. Cl. B60K 1/00; B65D 85/00

(52) U.S. Cl. 180/65.1; 206/372; 338/197

(57) ABSTRACT

A self propelled toolbox is provided with a plurality of storage compartments for storing tools. The toolbox is supported by two pairs of wheels. Each wheel of one of the pairs of wheels is a driven wheel that is mechanically coupled to an electric motor that causes the driven wheel to rotate about an axis to propel the toolbox. Each wheel of the other pair of wheels is a castor that is not operably linked to an electric motor and can pivot about an axis for steering the toolbox when the toolbox is in motion. The toolbox contains an energy reservoir in circuit communication with the electric motor for providing power to the electric motor. The quantity of power provided to the electric motor is controlled by a current controlling means that is accessible external of the toolbox by an operator of the self propelled toolbox. The two driven wheels may each be driven by the same electric motor, or they may each be driven by an electric motor that is mechanically coupled to only that wheel.

### FIELD OF THE INVENTION

The present invention relates to a toolbox provided with at least one electric motor that drives wheels of the toolbox to propel the toolbox.

### BACKGROUND OF THE INVENTION

Toolboxes used by mechanics in factories, aircraft hangers, auto repair shops, and even outdoor facilities have become increasingly larger. The larger toolboxes have the capacity to store large and heavy tools and supplies of components used in conjunction with the tools. The weight of a loaded toolbox can be very significant, and may require significant effort for moving the toolbox manually. A self propelled toolbox would reduce the manual effort required for moving the toolbox from place to place and could reduce incidents of muscle strains or back injuries incurred in moving the toolbox from place to place.

### DISCUSSION OF THE PRIOR ART

U.S. Pat. No. 6,945,580 B1 teaches a system for selectively moving a storage box along the length of a bed of a pickup truck. The bed of the pickup truck has a bottom wall, a first side wall, a second side wall and a front wall, said bottom wall having a rear edge. A pair of tracks are mounted on the bed of the pickup truck. A housing is located in the bed of the pickup truck. A plurality of wheels are rotatably coupled to and extend downwardly from the housing. Each of the wheels is positioned such that at least two wheels are positioned in each of the tracks. A motor is mounted in the housing and is mechanically coupled to at least one of said wheels for selectively rotating said at least one of said wheels in a first direction or a second direction. A control is operationally coupled to the motor. The control includes a first direction actuator and a second direction actuator. While this system allows a storage box to be moved along the length of the bed of a pickup truck, moving the storage box from one workplace to another requires the entire pickup truck to be moved, which is not necessarily convenient in a factory or an auto repair shop.

### SUMMARY OF THE INVENTION

There is provided in accordance with the present invention a self propelled toolbox provided with a plurality of storage compartments for storing tools. The toolbox is supported by two pairs of wheels. Each wheel of one of the pairs of wheels is a driven wheel that is mechanically coupled to an electric motor that causes the driven wheel to rotate about an axis to propel the toolbox. Each wheel of the other pair of wheels is a castor that is not operably linked to an electric motor and can pivot about an axis for steering the toolbox when the toolbox is in motion. The toolbox contains an energy reservoir in circuit communication with the electric motor for providing power to the electric motor. The quantity of power provided to the electric motor is controlled by a current controlling means that is accessible external of the toolbox by an operator of the self propelled toolbox. The two driven wheels may each be driven by the same electric motor, or they may each be driven by an electric motor that is mechanically coupled to only that wheel.

### BRIEF DESCRIPTION OF THE DRAWINGS

FIG. 1 is a perspective view of a prior art toolbox.

FIG. 2 is a front elevation view, partially broken away, of a self propelled toolbox according to a first embodiment of the invention.

FIG. 2A is an enlarged fragmentary front elevation view of the self propelled toolbox of FIG. 2, partially broken away.

FIG. 3 is a side elevation view, partially broken away, of the self propelled toolbox of FIG. 2.

FIG. 3A shows details of a device that controls the current provided to one or more motors in the self propelled toolbox.

FIG. 4 is a front elevation view, partially broken away, of a self propelled toolbox according to a second embodiment of the invention.

FIG. 5 is a fragmentary side elevation view of a lower portion of a self propelled toolbox according to a third embodiment of the invention.

FIG. 6 is an enlarged view of the lower right side portion of FIG. 5.

FIG. 7 is an exploded view of an assembly of an electric motor and drive wheels of the self propelled toolbox according to the third embodiment of the invention.

FIG. 8 is a fragmentary side elevation view of a lower portion of a self propelled toolbox according to a fourth embodiment of the invention.

FIG. 9 is an enlarged view of the lower right side portion of FIG. 8.

FIG. 10 is an exploded view of an assembly of an electric motor and drive wheels of the self propelled toolbox according to the fourth embodiment of the invention.

### DETAILED DESCRIPTION OF THE INVENTION

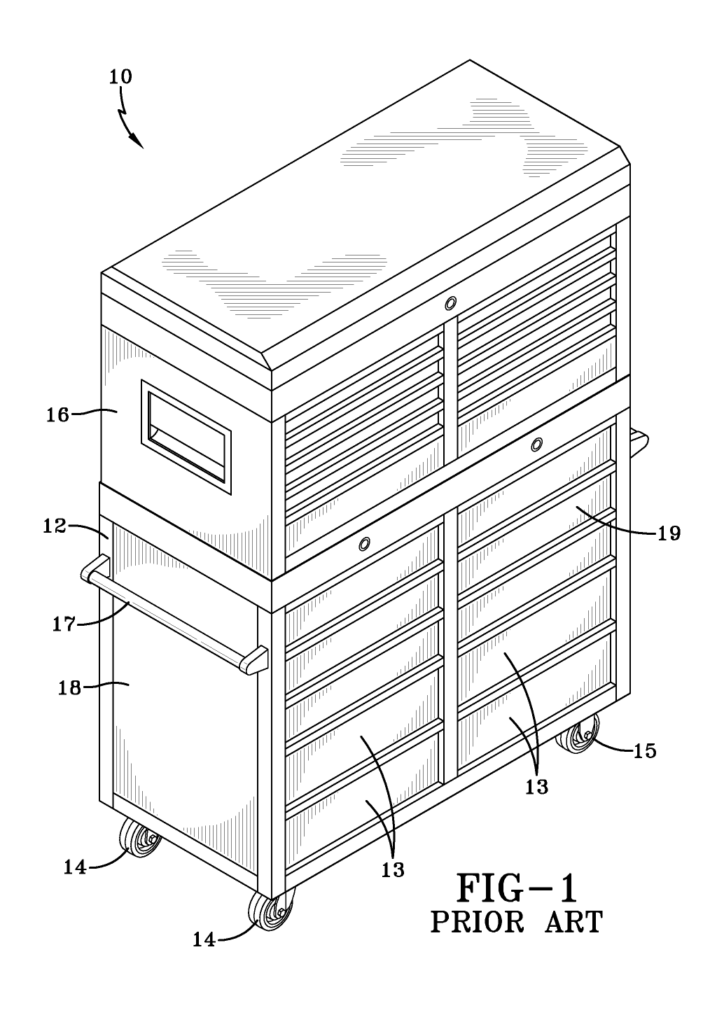

FIG. 1 is a perspective view of a typical prior art toolbox 10. The toolbox comprises a box 12 provided with a plurality of storage compartments 13 for storing tools. Many prior art toolboxes have a second box 16 that sits atop the box 12. It is understood that the box may be provided with a unitary construction with the boxes 12 and 16 combined as a single box. The box 12 is substantially rectangular when viewed from above. The box has a pair of opposed horizontally extending short sides 18 and a pair of opposed horizontally extending long sides 19. The storage compartments 13 are accessible at a long side of the box.

The box supported by two pairs of castor wheels 14, 15 that are fixed to a bottom side of the box. Each of the pairs of wheels is disposed in the vicinity of one of the short sides of the box.

A handle 17 is fixed to one of the horizontally extending short sides 18 of the box. The handle is used for pushing a prior art toolbox to manually move the toolbox from one location to another.

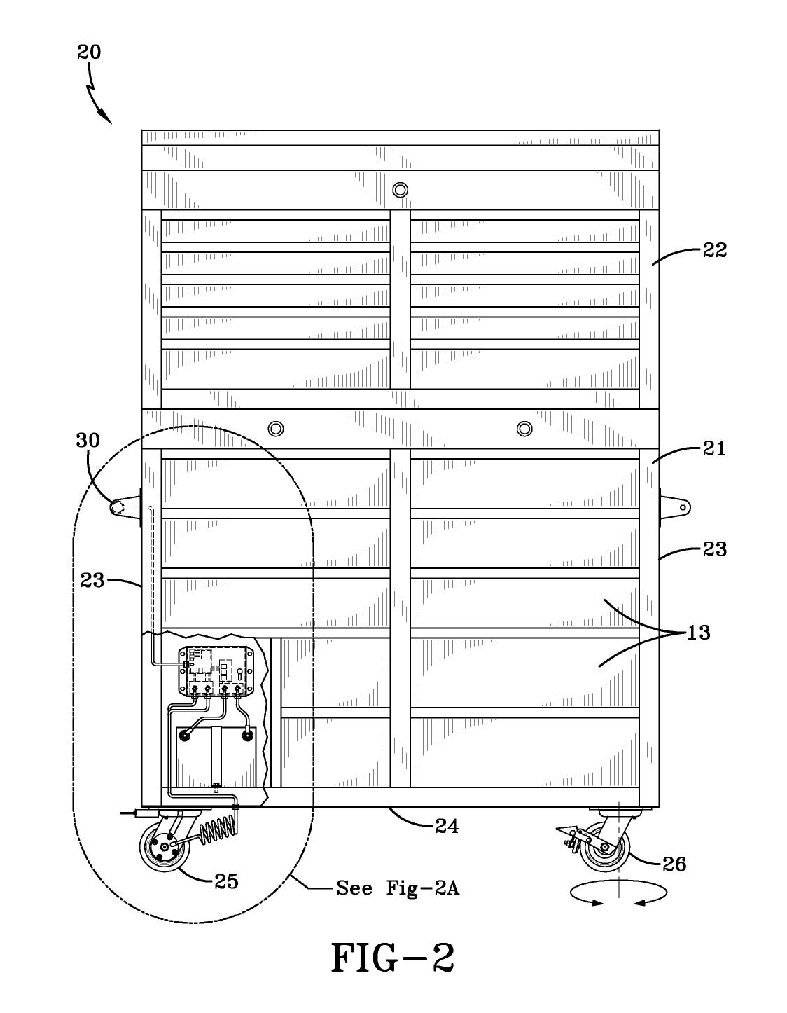

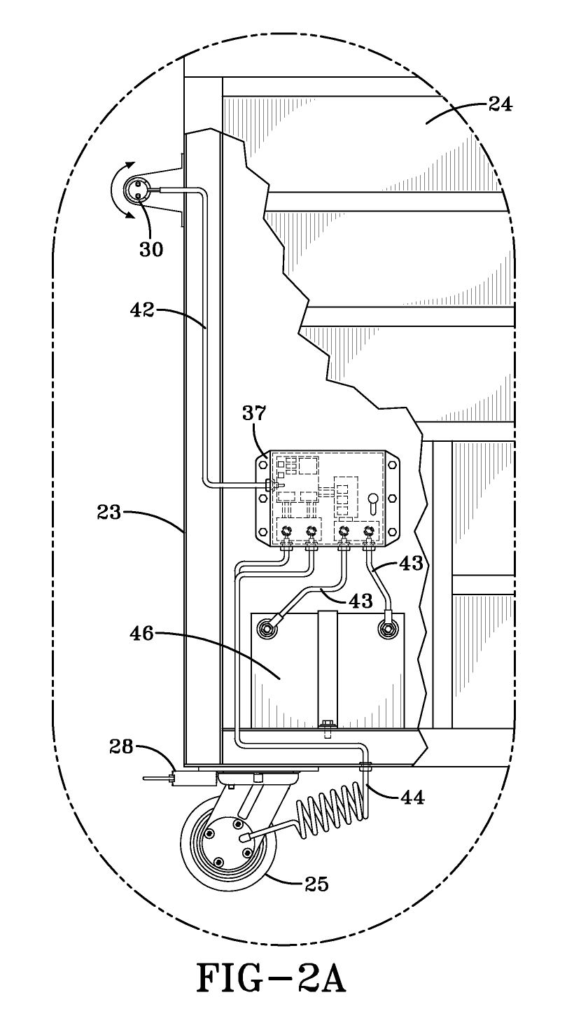

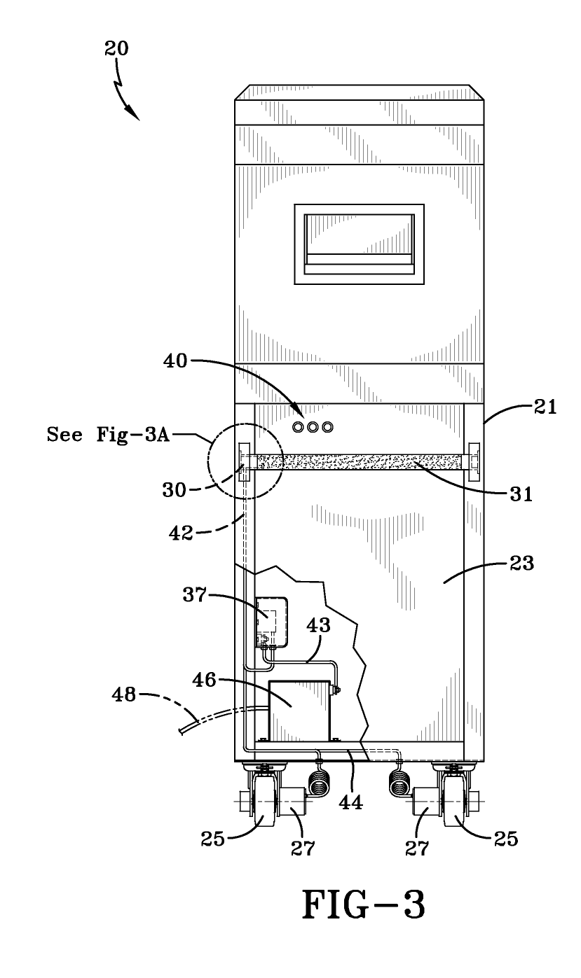

The basic structure of a self propelled toolbox according to the present invention is substantially like that of the above described prior art toolbox, however the new toolbox can be moved from one place to another without the manual exertion required by the prior art toolbox. A first embodiment of a self propelled toolbox of the present invention is presented in FIGS. 2-3A. FIG. 2 is a front elevation view, partially broken away of the self propelled toolbox 20; FIG. 2A is an enlarged fragmentary front elevation view of the self propelled toolbox of FIG. 2, partially broken away; FIG. 3 is a side elevation view, partially broken away; and FIG. 3A shows details of a device that controls the current provided to both motors of the self propelled toolbox.

The storage compartments 13 of the self propelled toolbox 20 may be arranged differently from those of the prior art toolbox to accommodate components of the propulsion mechanism. As in the prior art the self propelled toolbox the box 21 may support a second box 22 that sits atop the box 21. It is understood that the box may be provided with a unitary construction with the boxes 21 and 22 combined as a single box. The box 21 is substantially rectangular when viewed from above. The box has a pair of opposed horizontally extending short sides 23 and a pair of opposed horizontally extending long sides 24. The storage compartments 13 are accessible at a long side of the box.

The box 21 is supported by two pairs of wheels that are fixed thereto at a bottom side of the box. Each wheel 25 of one of the pairs of wheels being a driven wheel that is mechanically coupled to an electric motor 27 that causes the driven wheel to rotate about an axis to propel the toolbox. The self propelled toolbox of this first embodiment has two electric motors 27, each of the driven wheels 25 being mechanically coupled to one of the electric motors. It would be appropriate to employ DC motors for this purpose. As used herein and in the claims a driven wheel is understood to be a wheel that is caused to rotate by an electric motor that is mechanically coupled to the wheel. The driven wheels may be castors that can be locked in a non-pivoting state by a locking mechanism 28 with the driven wheels being coaxial when the driven wheels are being driven by an electric motor, as shown in FIG. 3. Alternatively the driven wheels may be permanently coaxial and unable to pivot.

As used herein and in the claims the term “castor” is understood to have its ordinary meaning of a pivoting wheel attached to the bottom of furniture or trucks or portable machines to make them movable. Castors used with the self propelled toolbox have a well known structure of an inverted U shaped frame with a pin or axle extending between the descending legs of the frame to provide an axis of rotation for a wheel mounted on the pin or axle such that the wheel rotates about the axis of rotation when the toolbox is moved. A pivot pin extends upwardly from the closed end of the U shaped frame to be received in a complementary well in a known manner to allow the castor to pivot about an axis that is perpendicular to the axis of rotation of the wheel.

Each wheel 26 of the other pair of wheels is a castor that is not operably linked to an electric motor and can pivot about an axis for steering the toolbox when the toolbox is in motion. The driven wheels 25 are disposed in the vicinity of one of the short sides 23 of the box and the non-driven castors 26 disposed in the vicinity of the other short side of the box.

The box contains an energy reservoir 46 in circuit communication with the electric motor for providing power to the electric motors 27. Preferably the energy reservoir is a rechargeable battery. A charging cord 48, shown in phantom in FIG. 3, is used to provide the energy reservoir with charging current from an electrical outlet, and the charging cord may be associated with an appropriate power converter as required by the battery. The battery, or batteries, is selected in accordance with appropriate engineering practice to be used with the electric motors 27. Indicator lights 40, or an indicator gauge, may be provided to inform an operator of the status of the charge of the energy reservoir.

In this first embodiment the motors 27 each have a driven member that is either mechanically coupled to or integral with the axle or pin to which the driven wheel 25 is mounted. The motors may be selected in accordance with good engineering practice to provide adequate torque to drive the driven wheels with sufficient force and speed to propel the toolbox.

The quantity of power provided to the electric motor, or motors, of a self propelled toolbox of the present invention is controlled by a current controlling means 30 that is accessible external of the box by an operator of the self propelled toolbox. With reference to FIGS. 3 and 3A the current controlling means 30 is a rheostat 32 mechanically coupled to a handle 31 fixed to a short side 23 of the toolbox by mounting brackets 33. The handle is fixed to the mounting brackets in a rotatable manner using bearings 35. The handle 31 has a horizontally extending longitudinal axis 34. The rheostat is adjusted by rotating the handle about the longitudinal axis as indicated in FIG. 2A. It is preferable that the handle be associated with a spring mechanism 36 that biases the handle to be in a position such that the rheostat 32 does not provide any power to the electric motor when an operator of the self propelled toolbox is not rotating the handle to cause the toolbox to move. It is understood that other mechanisms may be employed for adjusting the current controlling means including a lever or knob accessible at the exterior of the toolbox. In this first embodiment the current controlling means 30 is located at the same short side of the box as the pair of driven wheels 25. That is to say in this embodiment the driven wheels push the toolbox to move it.

A circuit board 37 or junction box is in circuit communication with the energy reservoir 46, the current controlling means 30 and the electric motor, or motors 27 via appropriate electrical conductors such as wires 42, 43, 44.

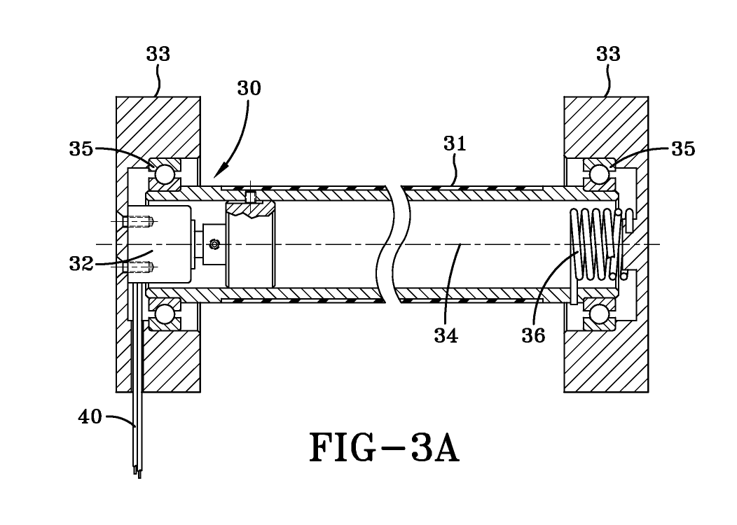

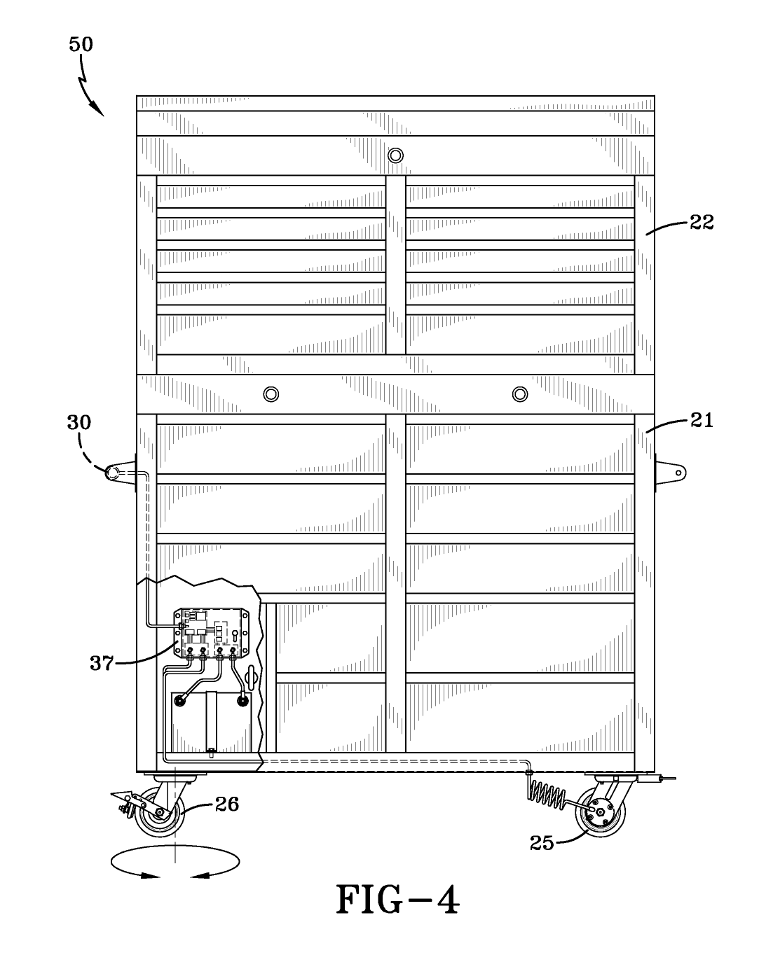

FIG. 4 is a front elevation view, partially broken away, of a self propelled toolbox 50 according to a second embodiment of the invention. This embodiment is substantially the same as the first embodiment with the exception that the current controlling means 30 is located at the opposite short side of the box from the driven wheels 25. The non-driven castors 26 are located at the same short side of the box as the current controlling means. That is to say in this embodiment the driven wheels pull the toolbox to move it.

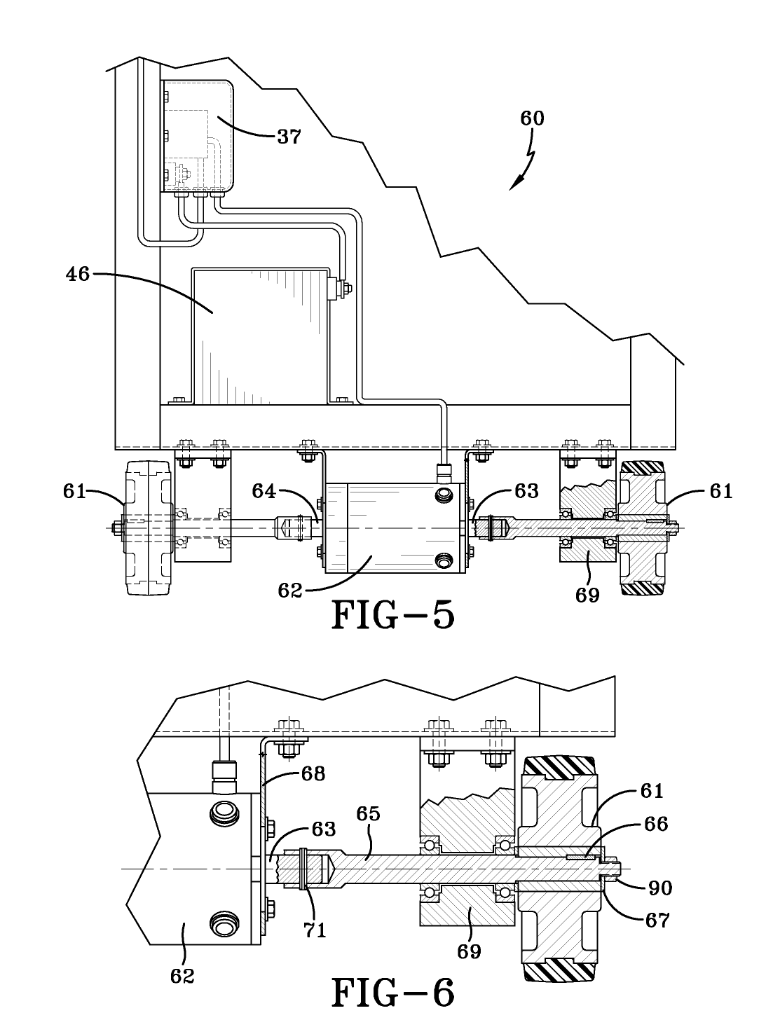

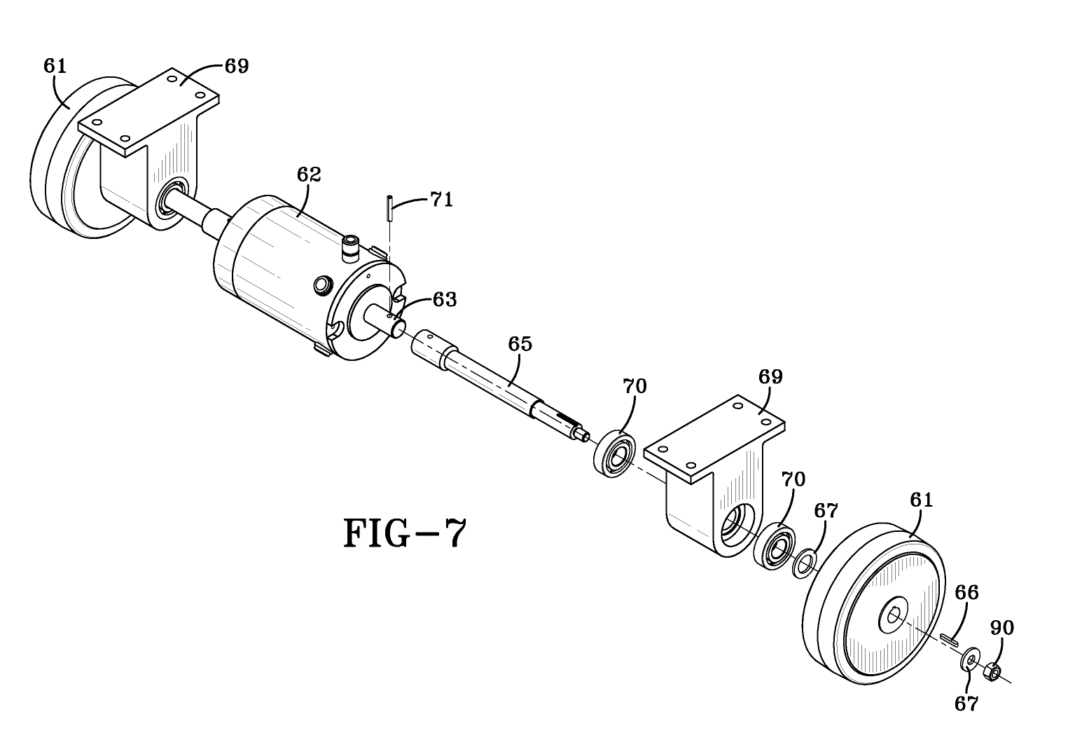

A third embodiment of a self propelled toolbox of the present invention is presented in FIGS. 5-7. FIG. 5 is a fragmentary side elevation view of a lower portion of a self propelled toolbox 60 according to the third embodiment; FIG. 6 is an enlarged view of the lower right side portion of FIG. 5; and FIG. 7 is an exploded view of an assembly of an electric motor and drive wheels of the self propelled toolbox according to the third embodiment.

The third embodiment has the features of the first two embodiments with the important distinction that in this embodiment both of the driven wheels 61 are permanently coaxial and one electric motor 62 is mechanically coupled to both of the driven wheels to rotate each of the driven wheels to propel the toolbox. It is appropriate to employ a DC motor for this purpose. It is preferable that the current controlling means be located at the opposite short side of the box from the pair of driven wheels such that the driven wheels pull the toolbox to propel it as shown and described with respect to the second embodiment. However, it is understood that the current controlling means may be located at the same short side of the box as the driven wheels such that the driven wheels push the toolbox as in the second embodiment.

The electric motor 62 is secured to a bottom surface of the toolbox using brackets 68 and has two coaxial rotating drive shafts 63, 64. The driven wheels 61 are each fixed to an axle 65 in a non-rotating manner using a key 66 fitted in corresponding keyways in the wheel and axle. Lock washers 67 and threaded fasteners 90 also contribute to securing the driven wheels to their associated axles. Bearing blocks 69 are fixed to the bottom surface of the toolbox using appropriate fasteners. Bearings 70 are disposed in each bearing block to support each axle in a rotatable manner. Each axle 65 is secured to a drive shaft 63, 64 of the electric motor in an appropriate manner such as a pin 71 such that the axle rotates with the corresponding drive shaft of the electric motor. Both axles and both drive shafts are coaxial making the driven wheels rotate about a common axis.

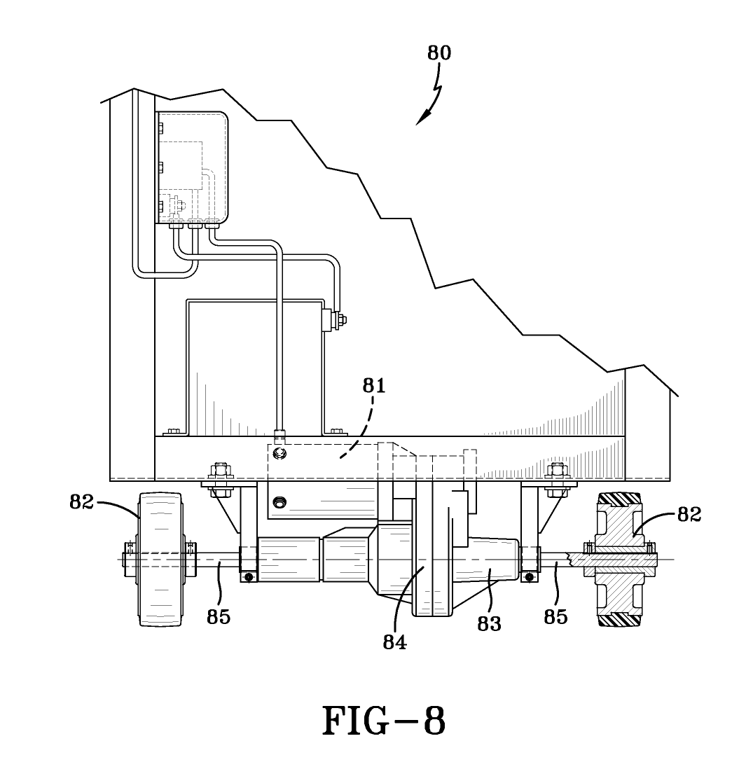

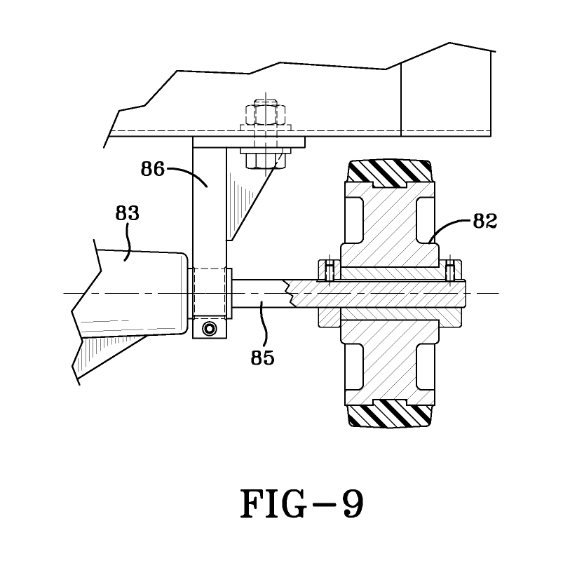

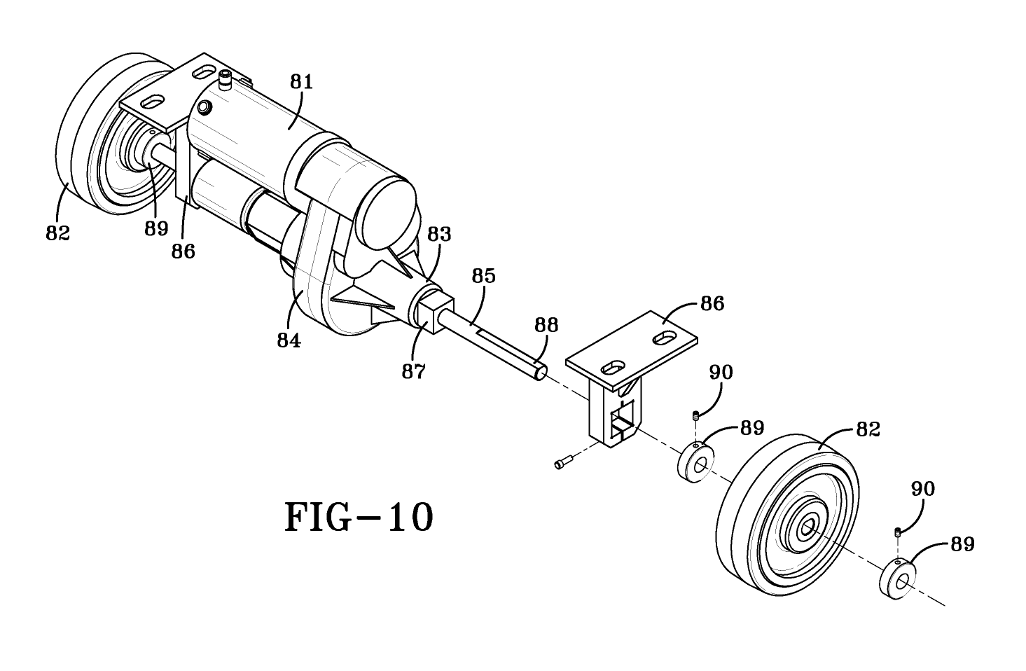

A fourth embodiment of a self propelled toolbox of the present invention is presented in FIGS. 8-10. FIG. 8 is a fragmentary side elevation view of a lower portion of the self propelled toolbox 80; FIG. 9 is an enlarged view of the lower right side portion of FIG. 8; and FIG. 10 is an exploded view of an assembly of an electric motor and drive wheels of the self propelled toolbox according to the fourth embodiment.

The fourth embodiment has the features of the first two embodiments with the important distinction that in this embodiment both of the driven wheels 82 are permanently coaxial and one electric motor 81 is mechanically coupled to both of the driven wheels via a powered axle 83 to rotate each of the driven wheels to propel the toolbox. Torque produced by the electric motor is transmitted to the powered axle by an appropriate enclosed transmission means 84 such as gears, or belts and pulleys. The lengths of the axle portions 85 of the powered axle may be such that the driven wheels 82 are fixed thereto. Bearing blocks 86 are fixed to the bottom surface of the toolbox using appropriate fasteners. Bearings 87 are disposed in each bearing block to support the axle in a rotatable manner. The axle portion 85 may have one or more flat surfaces 88 on its circumference to mate with set screws 90 that extend through retaining collars 89 to retain the driven wheels on the powered axle. It is understood that the driven wheels of the fourth embodiment may be secured to the axle in the same manner as described above with respect to the third embodiment, and vice versa. It is preferable that the current controlling means be located at the opposite short side of the box from the pair of driven wheels such that the driven wheels pull the toolbox to propel it as shown and described with respect to the second embodiment.

While the invention has been described with reference to certain exemplary embodiments, obvious modifications and alterations are possible by those skilled in the related art. Therefore, it is intended that the invention include all such modifications and alterations to the full extent that they come within the scope of the following claims or the equivalents thereof.

1. A self propelled toolbox comprising: a box provided with a plurality of storage compartments for storing tools, the box supported by two pairs of wheels that are fixed thereto, each wheel of one of the pairs of wheels being a driven wheel that is mechanically coupled to an electric motor that causes the driven wheel to rotate about an axis to propel the toolbox, each wheel of the other pair of wheels being a castor that is not operably linked to an electric motor and can pivot about an axis for steering the toolbox when the toolbox is in motion; the box containing an energy reservoir in circuit communication with the electric motor for providing power to the electric motor, the quantity of power provided to the electric motor being controlled by a current controlling means that is accessible external of the box by an operator of the self propelled toolbox.

2. The self propelled toolbox of claim 1 wherein the driven wheels are castors that can be locked in a non-pivoting state with the driven wheels being coaxial when the driven wheels are being driven by an electric motor.

3. The self propelled toolbox of claim 1 wherein the driven wheels are permanently coaxial and unable to pivot.

4. The self propelled toolbox of claim 1 wherein the box is substantially rectangular when viewed from above, the box having a pair of opposed horizontally extending long sides and a pair of opposed horizontally extending short sides, the storage compartments being accessible at a long side of the box, the pairs of wheels being located on a bottom side of the box with both of the driven wheels disposed in the vicinity of one of the short sides of the box and both of the castors disposed in the vicinity of the other short side of the box.

5. The self propelled toolbox of claim 4 wherein the current controlling means is located at the same short side of the box as the pair of driven wheels.

6. The self propelled toolbox of claim 4 wherein the current controlling means is located at the opposite short side of the box from the driven wheels.

7. The self propelled toolbox of claim 1 comprising two electric motors, each of the driven wheels being mechanically coupled to one of the electric motors.

8. The self propelled toolbox of claim 5 comprising two electric motors, each of the driven wheels being mechanically coupled to one of the electric motors.

9. The self propelled toolbox of claim 6 comprising two electric motors, each of the driven wheels being mechanically coupled to one of the electric motors.

10. The self propelled toolbox of claim 1 comprising only one electric motor that is mechanically coupled to both of the driven wheels.

11. The self propelled toolbox of claim 5 comprising only one electric motor that is mechanically coupled to both of the driven wheels.

12. The self propelled toolbox of claim 6 comprising only one electric motor that is mechanically coupled to both of the driven wheels.

13. The self propelled toolbox of claim 1 wherein the current controlling means is a rheostat that is mechanically coupled to a handle fixed to a side of the toolbox, the handle having a horizontally extending longitudinal axis, and the rheostat is adjusted by rotating the handle about the longitudinal axis.

14. The self propelled toolbox of claim 13 wherein the handle includes a spring that biases the handle to a position wherein the rheostat provides no power to the motor.

15. A self propelled toolbox comprising: a box that is substantially rectangular when viewed from above provided with a plurality of storage compartments for storing tools therein, the box having a pair of opposed horizontally extending long sides and a pair of opposed horizontally extending short sides, the storage compartments being accessible at a long side of the box, the box supported by two pairs of wheels that are fixed thereto at a bottom side of the box, two electric motors, each wheel of one of the pairs of wheels being a driven wheel that is mechanically coupled to one of the electric motors that causes the driven wheel to rotate about an axis to propel the toolbox, each wheel of the other pair of wheels being a castor that is not operably linked to an electric motor and can pivot about an axis for steering the toolbox when the toolbox is in motion; the box containing an energy reservoir in circuit communication with the electric motor for providing power to the electric motor, the quantity of power provided to the electric motor being controlled by a rheostat that is mechanically coupled to a handle fixed to a substantially vertically oriented short side of the box, the handle having a horizontally extending longitudinal axis, and the rheostat is adjusted by rotating the handle about the longitudinal axis, the driven wheels are coaxial and located in the vicinity of the short side of the box opposite the short side of the box to which the handle is fixed, and both of the castors are located in the vicinity of the short side of the box to which the handle is fixed.

16. The self propelled toolbox of claim 15 wherein the energy reservoir is a rechargeable battery.

17. The self propelled toolbox of claim 15 further comprising a circuit board that is in circuit communication with the energy reservoir, the rheostat and both of the electric motors.

18. A self propelled toolbox comprising: a box that is substantially rectangular when viewed from above provided with a plurality of storage compartments for storing tools therein, the box having a pair of opposed horizontally extending long sides and a pair of opposed horizontally extending short sides, the storage compartments being accessible at a long side of the box, the box supported by two pairs of wheels that are fixed thereto at a bottom side of the box, both wheels of one of the pairs of wheels being driven wheels that are coaxial, one electric motor that is mechanically coupled to both of the driven wheels to rotate each of the driven wheels to propel the toolbox, each wheel of the other pair of wheels being a castor that is not operably linked to an electric motor and can pivot about an axis for steering the toolbox when the toolbox is in motion; the box containing an energy reservoir in circuit communication with the electric motor for providing power to the electric motor, the quantity of power provided to the electric motor being controlled by a rheostat that is mechanically coupled to a handle fixed to a substantially vertically oriented side of the box, the handle having a horizontally extending longitudinal axis, and the rheostat is adjusted by rotating the handle about the longitudinal axis, the driven wheels are coaxial and located in the vicinity of the short side of the box opposite the short side of the box to which the handle is fixed, and both of the castors are located in the vicinity of the short side of the box to which the handle is fixed.

19. The self propelled toolbox of claim 18 wherein the energy reservoir is a rechargeable battery.

20. The self propelled toolbox of claim 18 further comprising a circuit board that is in circuit communication with the energy reservoir, the rheostat and the electric motor.
